(19) United States
(12) Patent Application Publication
(10) Pub. No.: US 2008/0295414 A1
(43) Pub. Date: Dec. 4, 2008

(54) Automotive weather strip

(76) Inventors: Naohisa Miyakawa, Shiroi-shi (JP); Takashi Hirokawa, Shiroi-shi (JP); Katsuhisa Kato, Inzai-shi (JP)

Correspondence Address: WENDEROTH, LIND & PONACK, L.L.P., 2033 K STREET N. W., SUITE 800, WASHINGTON, DC, 20006-1021, US

(21) Appl. No.: 12/078,559

(22) Filed: Apr. 1, 2008

(30) Foreign Application Priority Data
Apr. 2, 2007 (JP) 2007-120120

(51) Int. Cl. E06B 7/16

(52) U.S. Cl. 49/490.1

(57) ABSTRACT

An automotive weather strip mounted on a flange at the peripheral edge of various openings in a vehicle body such as an automotive door, trunk, and back door includes a weather strip body. The weather strip body includes a coating layer having a hollow seal part, which is made of thermoplastic elastomer, and a core material having a substantially U-shaped cross section, which is made of a hard synthetic resin. A seal pad part made of thermoplastic elastomer is provided on the inner bottom surface of the core material having a substantially U-shaped cross section or on the coating layer provided on the inner bottom surface of the core material having a substantially U-shaped cross section. The seal pad part is formed with a large number of protrusions on the surface thereof facing to a flange.

### BACKGROUND OF THE INVENTION

1. Field of the Invention

The present invention relates to a weather strip mounted on a flange at the peripheral edge of various openings in a vehicle body such as an automotive door, trunk, and back door.

2. Description of the Related Art

A conventional weather strip mounted on a flange at the peripheral edge of various openings in a vehicle body such as an automotive door, trunk, and back door includes a weather strip body 1 shown in FIGS. 5 and 6. The weather strip body 1 is formed by integrally molding a hollow seal part 2 and a core material 3 having a substantially U-shaped cross section, which is made of a hard synthetic resin. A seal pad part 4 having a flat surface 14, which is made of thermoplastic elastomer, is molded integrally, on an inner bottom surface 6 on the inside of the core material 3 having a substantially U-shaped cross section, and the seal pad part 4 is elastically pressed on a flange end part 13 of a flange 12, by which the weather strip is mounted on a vehicle body panel 11. Thereby, the sealing performance is improved to prevent water from entering and to prevent noise etc. during running. However, since the seal pad part 4 having the flat surface 14 comes into contact with the flange end part 13 on the entire surface of the flange 12, the conventional weather strip has a drawback in that a complete seal cannot be provided because of the large restoring force of the seal pad part 4, so that a gap is produced between the seal pad part 4 and the flange 12. Also, there arises a problem in that the flange 12 that is a partial thick-wall part of the vehicle body panel 11 has further increased restoring force and the like problems.

### SUMMARY OF THE INVENTION

The present invention has been made to solve the above problems, and accordingly an object of the present invention is to provide an automotive weather strip, wherein a seal pad part made of thermoplastic elastomer, which is integrally molded on the inner bottom surface of a core material having a substantially U-shaped cross section, is formed with a large number of protrusions to prevent a gap from being produced between the seal pad part and a flange, whereby noise is prevented, and the sealing performance is improved.

To achieve the above object, the weather strip in accordance with the present invention includes a weather strip body mounted on a flange at the peripheral edge of an opening in a vehicle body, and the weather strip body includes a core material having a substantially U-shaped cross section, which is made of a hard synthetic resin, a coating layer for covering the core material, and a hollow seal part formed integrally with the coating layer. A seal pad part made of thermoplastic elastomer is provided on the inner bottom surface of the core material having a substantially U-shaped cross section or on the coating layer provided on the inner bottom surface of the core material, and the seal pad part is formed with a large number of protrusions on the surface thereof facing to the flange. Also, the seal pad part having the large number of protrusions is extended to the inner side surfaces facing to each other of the core material or to the coating layers provided on the inner side surfaces.

According to the weather strip body in accordance with the present invention, the seal pad part formed with the large number of protrusions on the surface thereof facing to the flange is provided on the inner bottom surface of the core material having a substantially U-shaped cross section, which is made of a hard synthetic resin, or on the coating layer provided on the inner bottom surface. Therefore, the large number of protrusions are easily crushed because the restoring force is remarkably small as compared with the pressing force of the end tip of the flange, and thereby a gap between the seal pad part and the tip end of flange is filled completely, so that water can be prevented from entering, and noise during running can be reduced remarkably. Also, the seal pad part formed with the large number of protrusions is extended to the inner side surfaces facing to each other of the core material or to the coating layers provided on the inner side surfaces. Therefore, the seal pad part and the core material or the coating layer are integrated with each other further firmly, so that even if the tip end position of flange moves to the right and left of the side surface of the core material, the seal pad part and the flange are sealed completely.

### BRIEF DESCRIPTION OF THE DRAWINGS

FIG. 1 is a vertically sectional side view of a weather strip body in accordance with a first embodiment of the present invention;

FIG. 2 is a vertically sectional side view of a modification of the weather strip body shown in FIG. 1;

FIG. 3 is a vertically sectional side view showing an embodiment in which a weather strip body in accordance with the present invention is mounted on a flange of a vehicle v body panel;

FIG. 4 is a vertically sectional side view showing another embodiment in which a weather strip body in accordance with the present invention is mounted on a flange of a vehicle body panel;

FIG. 5 is a vertically sectional side view of a conventional weather strip;

FIG. 6 is a vertically sectional side view showing a state in which a conventional weather strip is mounted on a flange of a vehicle body panel;

FIG. 7 is a schematic view showing a manufacturing process for a weather strip in accordance with the present invention;

FIG. 8 is a partially cut perspective view of a core material in accordance with the present invention;

FIG. 9 is a vertically sectional side view of a weather strip body in accordance with a second embodiment of the present invention, in which a coating layer is put at the outer periphery and inner periphery of a core material; and

FIG. 10 is a vertically sectional side view of a weather strip body in accordance with the present invention, in which a non-fusion bonded part of a coating layer is formed in a part of the inner side surface of a core material.

### DETAILED DESCRIPTION OF THE PREFERRED EMBODIMENTS

An automotive weather strip in accordance with a first embodiment shown in FIGS. 1 to 4 includes a weather strip body 1 mounted on a flange at the peripheral edge of various openings in a vehicle body such as an automotive door, trunk, and back door. The weather strip body 1 includes a core material 3 having a substantially U-shaped cross section, which is formed by extrusion molding a hard synthetic resin in the lengthwise direction, a hollow seal part 2 integrally formed by extrusion molding thermoplastic elastomer on the outside of the core material 3, and a coating layer 8. The core material 3 having a substantially U-shaped cross section has an inner bottom surface 6 and inner side surfaces 7 on the inside thereof. On the inner bottom surface 6 of the core material 3, a seal pad part 4 formed by extrusion molding thermoplastic elastomer is provided, and the seal pad part 4 is formed with a large number of protrusions 5 in the saw-toothed shape on the surface facing to the flange. The large number of protrusion 5 is formed in the saw-toothed shape of the regular form or the irregular form. The coating layer 8 provided on the inner side surfaces 7 facing to each other of the core material 3 having a substantially U-shaped cross section is provided with holding pieces 9 for holding the flange which are projectingly provided so as to face to each other. The hollow seal part 2 can be formed into a square shape, a circular shape, an elliptical shape, or the like shape.

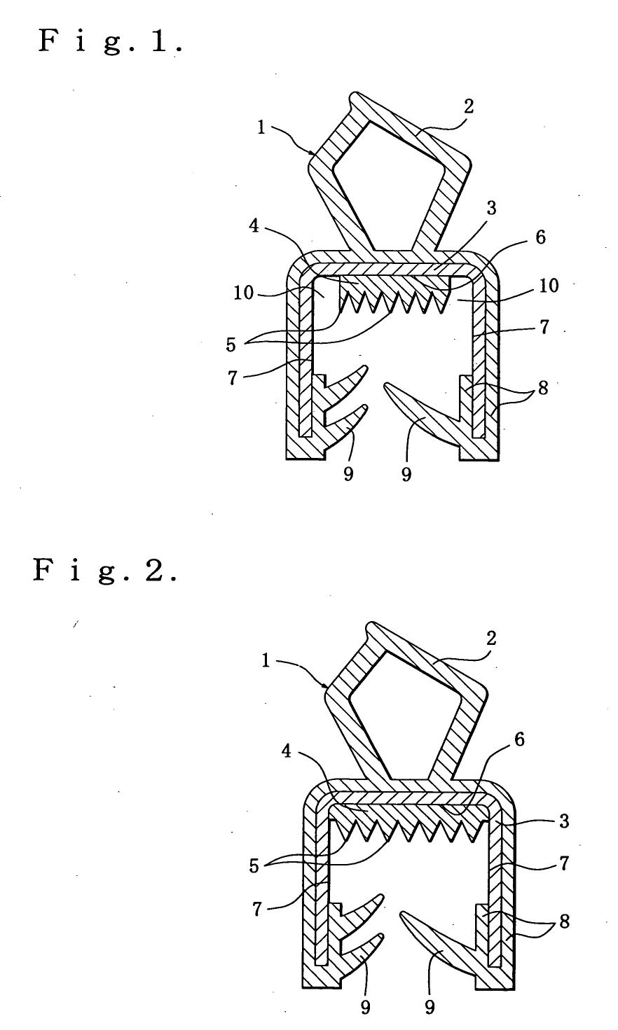

As shown in FIG. 1, the seal pad part 4 having the large number of protrusions 5 is provided only in a part, that is, a central part of the inner bottom surface 6 of the core material 3 having a substantially U-shaped cross section, and space parts 10 are formed between the inner side surfaces 7 facing to each other of the core material 3 and the seal pad part 4. As a modification of the weather strip body 1, the seal pad part 4 having the large number of protrusions 5 can be formed so as to extend to the inner side surfaces 7 facing to each other of the core material 3 as shown in FIGS. 2 to 4. Further, as shown in FIG. 10, the coating layer 8 provided on the inner side surface 7 of the core material 3 can include a non-fusion bonded part 17 that is not fusion bonded to the core material 3.

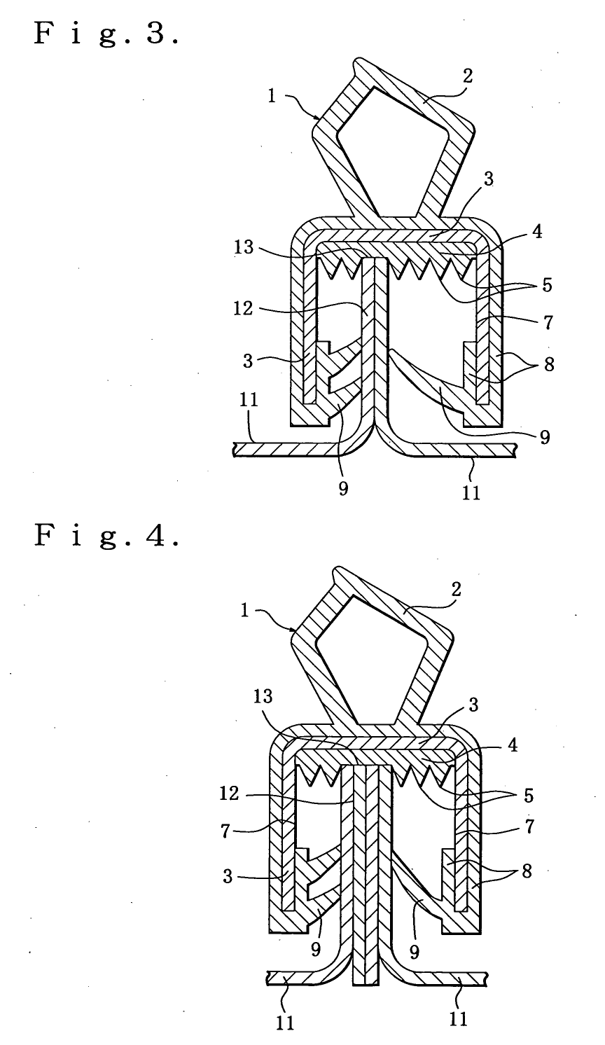

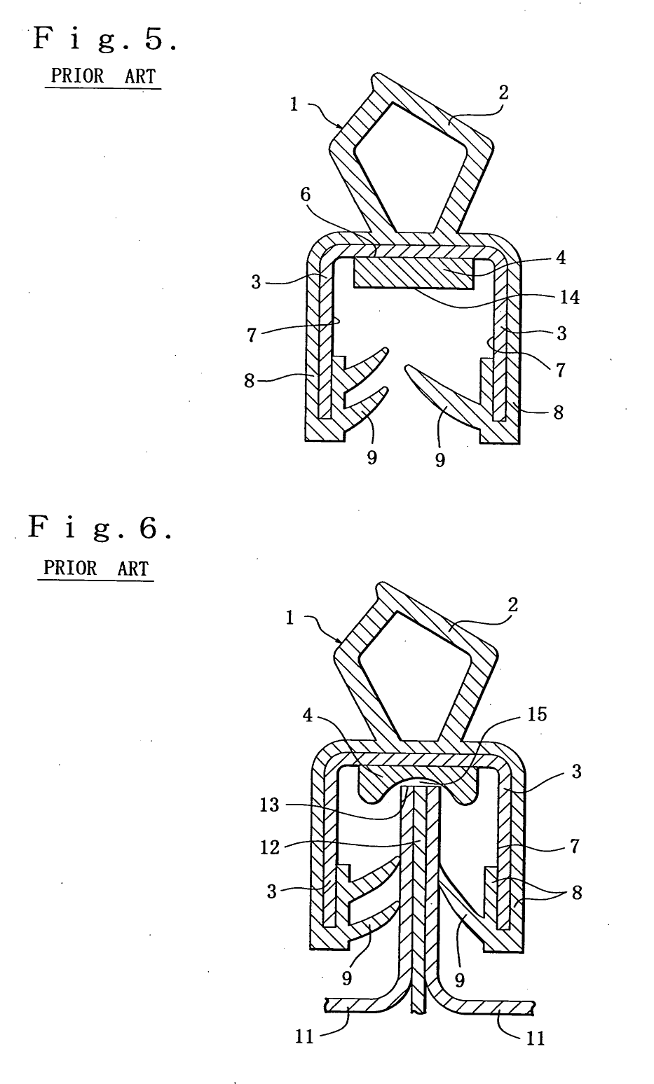

FIG. 3 shows a state in which the weather strip body 1 in accordance with the present invention shown in FIG. 2 is mounted on a flange 12 of a vehicle body panel 11, and FIG. 4 shows the weather strip body 1 shown in FIG. 2, which is in a state of being mounted on the flange 12 having a thick flange end part 13.

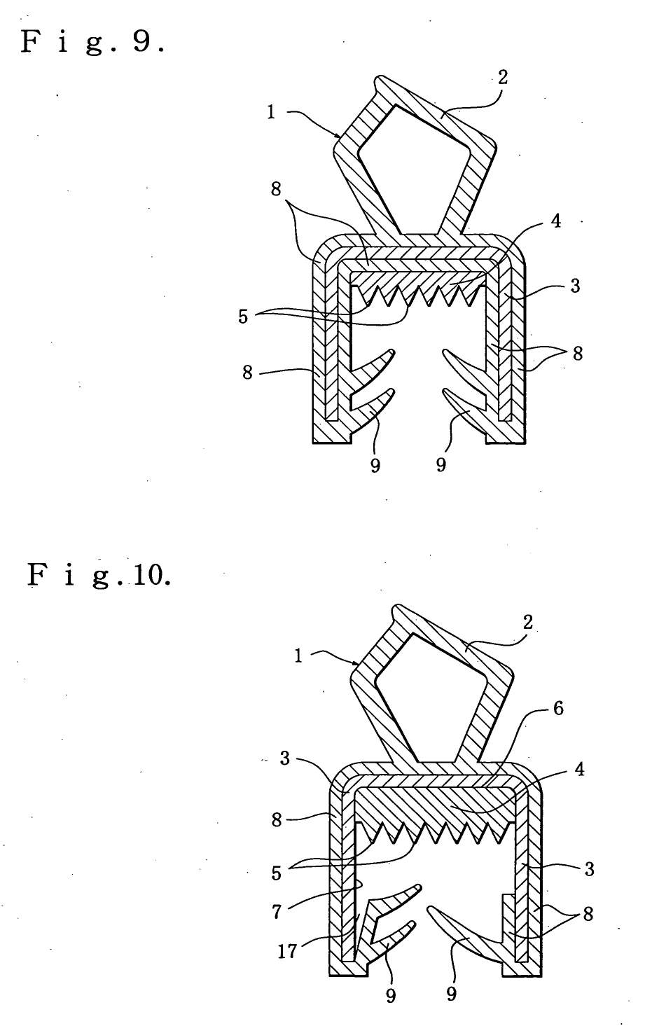

The weather strip body 1 in accordance with a second embodiment shown in FIG. 9 includes the core material 3 having a substantially U-shaped cross section, which is made of a hard synthetic resin, and a coating layer 8 having the hollow seal part 2, which is integrally formed by extrusion molding thermoplastic elastomer onto the whole of the inside and outside of the core material 3. The core material 3 having a substantially U-shaped cross section has the inner bottom surface 6 and the inner side surfaces 7 on the inside thereof. The coating layer 8 provided on the inner bottom surface 6 of the core material 3 is provided with the seal pad part 4 formed by extrusion molding thermoplastic elastomer, and the seal pad part 4 is provided with the large number of protrusions 5 formed in the surface facing to the flange. The coating layers 8 provided on the inner side surfaces 7 facing to each other of the core material 3 is provided with the holding-pieces 9 for holding the flange which are projectingly provided so as to face to each other. the seal pad part 4 having the large number of protrusions 5 can be extended to the coating layers 8 provided on the inner side surfaces 7 facing to each other of the core material 3 as shown in FIG. 9, or the space parts 10 can be formed between the coating layers 8 provided on the inner side surfaces 7 of the core material 3 and the seal pad part 4 by providing the seal pad part 4 only in the central part of the coating layer 8 provided on the inner bottom surface 6 of the core material 3 as shown in FIG. 1.

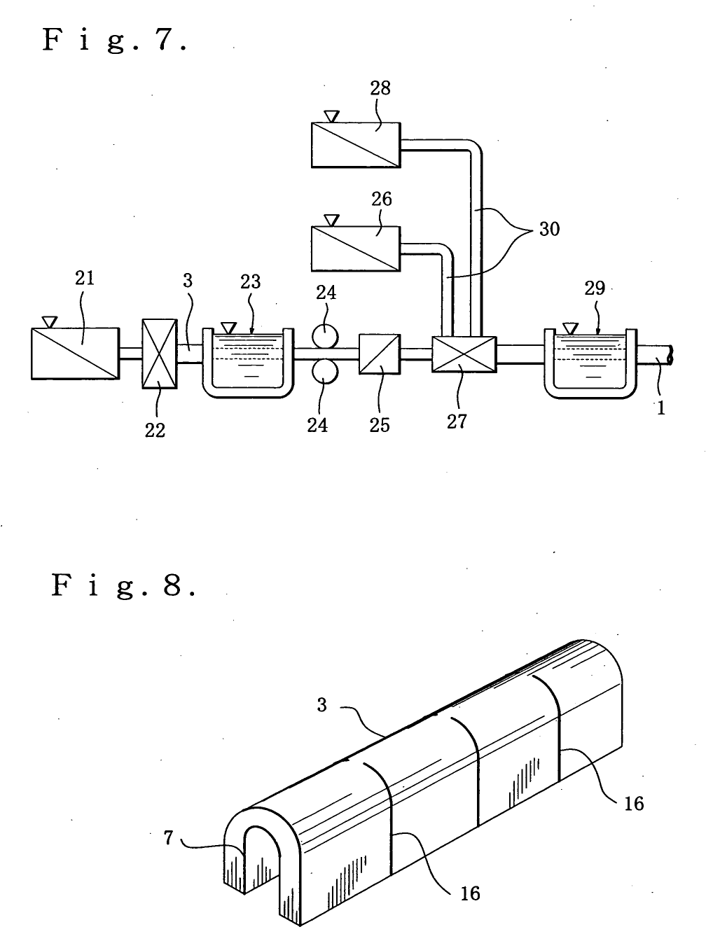

FIG. 7 shows an embodiment of a manufacturing method for the weather strip in accordance with the present invention. In this method, a synthetic resin is poured into a first extrusion molding machine 21, and the core material 3 having a substantially U-shaped cross section is formed by using a first mold die 22. After the core material 3 has passed through a first cooling water thank 23 and than via a receiving roller 24, cut parts 16 are formed in the inner side surfaces 7 of the core material 3 having a substantially U-shaped cross section by using a cutting machine 25 as shown in FIG. 8, the cut parts 16 each being cut into a desired shape. Thereafter, the core material 3 enters into a second mold die 27, where thermoplastic elastomer in a molten state, which is poured into a second extrusion molding machine 26 for forming the hollow seal part 2 and the coating layer 8, and thermoplastic elastomer in a molten state, which is poured into a third extrusion molding machine 28 for forming the seal pad part 4, are fusion bonded to the inner bottom surface 6 of the core material 3 to form the weather strip body 1. Then, the weather strip body 1 passes through a second cooling water tank 29. In the case where two kinds of thermoplastic elastomer having different hardness are used for the hollow seal part 2 and the coating layer 8, another extrusion molding machine is additionally installed to perform extrusion molding in the second mold die 27. The core material 3 and the coating layer 8 are fusion bonded to each other. However, as shown in FIG. 10, the non-fusion bonded part 17 that is not fusion bonded partially to the core material 3 may be formed. Reference numeral 30 denotes a filling pipe.

Next, the material used in the present invention is explained. For the synthetic-resin core material 3 having a substantially U-shaped cross section, an olefin-based resin and olefin-based thermoplastic elastomer having a hardness HDA (JIS K6253, value after 15 seconds) of 85 or higher or a mixed synthetic resin formed by mixing 20 to 50 weight % or powder such as talc with the synthetic resins is used to enhance the rigidity and to decrease the linear expansion coefficient. For example, by using a mixed synthetic resin formed by mixing 40 weight % of talc powder with 60 weight % of polypropylene resin, the linear expansion coefficient can be decreased to one-quarter or lower compared with the synthetic-resin core material made of 100 weight % of polypropylene resin.

As the thermoplastic elastomer for forming the hollow seal part 2, olefin-based thermoplastic elastomer having a hardness HDA (JIS K6253, value after 15 seconds) of 20 to 60 or a foam thereof, or styrene-based thermoplastic elastomer or a foam thereof is used. For the seal pad part 4 formed with the large number of protrusions 5, olefin-based thermoplastic elastomer having a hardness HDA (JIS K6253, value after 15 seconds) lower than 30 or lower or a foam thereof, or styrene-based thermoplastic elastomer or a foam thereof is used, and preferably, olefin-based thermoplastic elastomer having a hardness HDA (JIS K6253, value after 15 seconds) of 1 to 20 or a foam thereof, or styrene-based thermoplastic elastomer or a foam thereof may be used.

As the thermoplastic elastomer for forming the coating layer 8, olefin-based thermoplastic elastomer having a hardness HDA (JIS K6253, value after 15 seconds) of 40 to 80 or a foam thereof, or styrene-based thermoplastic elastomer or a foam thereof is used.

1. An automotive weather strip comprising a weather strip body (1) mounted on a flange at the peripheral edge of a vehicle body opening such as an automotive door, trunk, and back door, wherein the weather strip body (1) includes a core material (3) having a substantially U-shaped cross section, which is made of a hard synthetic resin, and a coating layer (8) having a hollow seal part (2), which is provided on the outside of the core material (3) and is made of thermoplastic elastomer; a seal pad part (4) made of thermoplastic elastomer is provided at least in a part of an inner bottom surface (6) of the core material (3) having a substantially U-shaped cross section; and the seal pad part (4) is formed with a large number of protrusions (5) on the surface thereof that comes into contact with a flange.

2. The automotive weather strip according to claim 1, wherein the seal pad part (4) having the large number of protrusions (5) extends to inner side surfaces (7) facing to each other of the core material (3).

3. The automotive weather strip according to claim 1, wherein the coating layer (8) is provided in a part on the inside of the core material (3).

4. The automotive weather strip according to claim 1, wherein the coating layer (8) is provided in a whole on the inside of the core material (3).

5. The automotive weather strip according to claim 4, wherein the seal pad part (4) having a large number of protrusions (5) is provided at least in a part of the coating layer (8) provided on an inner bottom surface (6) of the core material (3).

6. The automotive weather strip according to claim 5, wherein the seal pad part (4) having the large number of protrusions (5) extends to the coating layers (8) provided on inner side surfaces (7) facing to each other of the core material (3).
